(19) United States
(12) Patent Application Publication
(10) Pub. No.: US 2007/0296796 A1
(43) Pub. Date: Dec. 27, 2007

(54) METHOD OF ENHANCING HOMOGENEITY DURING MASS PRODUCTION MANUFACTURE OF A COLOR FILTER SUBSTRATE

(75) Inventors: Kwang-Ho Lee, Seoul (KR); Yoon-Ho Kang, Gyeonggi-do (KR); Jae-Jun Yu, Gyeonggi-do (KR); Byoung-Joo Kim, Gyeonggi-do (KR); Jang-Sub Kim, Gyeonggi-do (KR); Seong-Gyu Kwon, Gyeonggi-do (KR); Yi-Seop Shim, Gyeonggi-do (KR); Chang-Hun Kwak, Gyeonggi-do (KR)

Correspondence Address: MACPHERSON KWOK CHEN & HEID LLP, 2033 GATEWAY PLACE, SUITE 400, SAN JOSE, CA, 95110, US

(73) Assignee: Samsung Electronics Co., Ltd.

(21) Appl. No.: 11/765,665

(22) Filed: Jun. 20, 2007

(30) Foreign Application Priority Data
Jun. 22, 2006 (KR) 2006-56147

(51) Int. Cl. G02B 5/20

(52) U.S. Cl. 347/107

(57) ABSTRACT

A method of manufacturing a color filter substrate includes ejecting color inks into a first sub-array of ink-receiving openings defined in or on a base substrate by using a print head unit including a plurality of ejecting nozzles, rotating relatively one of the base substrate and the print head unit and ejecting color inks into a second sub-array of ink-receiving openings defined in or on the base substrate where the first and second sub-array of ink-receiving openings are interlaced with each other

### CROSS-REFERENCE TO RELATED APPLICATIONS

This application relies for priority upon Korean Patent Application No. 2006-0056147 filed on Jun. 22, 2006, the disclosure of which is incorporated herein by reference.

### BACKGROUND

1. Field of Invention

The present disclosure of invention relates to a method of manufacturing a color filter substrate such as one used in liquid crystal displays (LCD's). More particularly, the present disclosure relates to a method of manufacturing a color filter substrate for improving uniformity of image appearance across a matrix of color filters formed by nozzled ejection of ink.

2. Description of Related Art

In general, a liquid crystal display (LCD) panel includes a lower transparent substrate that is structured to contain an array of switching devices (i.e., TFT's) and an upper transparent substrate having a matrix of color filters disposed therein for defining colors of corresponding pixel areas of the LCD panel. The color-filters containing substrate is typically disposed in facing opposition to the lower substrate and a liquid crystal material layer is disposed between the lower substrate and the upper substrate. The upper substrate typically includes a light blocking mesh (e.g., a matrix of orthogonal black or other nontransmissive stripes) through which a corresponding matrix of light passage openings are formed. Color filters for passing different frequency bands of light, such as of a red color, a green color and a blue color; are typically formed periodically in respective ones of the light passage openings. The color filters may be formed by various methods such as a dyeing method, a pigment ejecting method, an electrode positioning method, a printing method and so on. In one class of embodiments, hardenable inks of differing colors are injected through electrically controlled nozzles and into the light passage openings so as to form a corresponding matrix of differently colored, color filters.

Prior to hardening, the inks that are used for forming the color filters typically have a viscosity of between about 6 cp (centi poise) to about 15 cp and a surface tension of between about 25N/m to about 35N/m. The inks may be injected as continuous streams into each of the light passage openings; or in the case where digital control of ink volume is desired, as a counted plurality of ejected ink droplets for each of the openings. When one to about thirty drops of the ink are pulse-wise ejected into an opening, the ink droplets tend to adhere to a substrate area beneath the openings and they tend to take on dome shapes (i.e., convex meniscuses) due to fluid cohesion, fluid viscosity and/or surface tension characteristics of the fluid ink. The degree to which the ejected ink is dome-shaped after hardening may vary from one nozzle to another due to differences in the way individual nozzles eject the ink into respective openings. When the ink ejected into the openings is later hardened, there is a significant danger that the one or more domes shapes in each opening will be persistently retained to at least some extent and therefore varying thickness of the colored ink in each of immediately adjacent openings will create a persistently not planar series of the top surface of the adjacently deposited filters due to persistent characteristics of the originally injected and adhered droplets. Non-uniformity of the thickness of the hardened ink in each color filter and/or nonplanarity of at least one major surface in each color filter can cause an undesirable refraction of light, an irregularity of liquid crystal material interposed between the upper and lower substrates and thus a deterioration of color reproducibility across the LCD panel. This effect can be most noticeable and most annoying if it is persistently repeated among immediately adjacent pixel areas rather than being randomly dispersed.

In one class of embodiments, an inkjet printer is provided with a plurality of print heads where each print head has a plurality of electrically controllable injection nozzles for selectively ejecting droplets of the ink of the corresponding print head. Conventional techniques for providing uniform and excellent color reproducibility of color filters formed with such inkjet printers include assuring that each liquid ink drop ejected by a given nozzle is substantially uniform, or adjusting the viscosity property of the ink drops by way of temperature control or other means, or adjusting the surface repulsive force seen between the ink drops and the support surface under the light blocking pattern. However, even when the above-mentioned methods for uniformizing the color filters are used during mass production, the nozzle-based ejecting of ink droplets from of each of the print heads still results in a significant amount of persistent nonuniformity of thickness of the color filters when measured across large area LCD panels due to idiosyncrasies of individual nozzles.

### SUMMARY

A first method of manufacturing a color filters-containing substrate in accordance with the disclosure includes: (a) maintaining a multi-nozzle print head in a first angular orientation while ejecting color ink droplets into a first sub-array of openings defined in or over a base substrate; (b) changing the angular orientation of the multi-nozzle print head relative to the base substrate to a second different angular orientation; and (c) while the multi-nozzle print head is in the second angular orientation, ejecting color ink droplets into a second sub-array of openings defined in or over the base substrate; where the first and second sub-array of openings are interlaced with one another. In one embodiment, the switch between the first and second angular orientations assures that a same one print head nozzle (with its unique idiosyncrasies) will not solely eject ink into immediately adjacent openings of both the first and second interlaced sub-arrays of openings. Instead a pseudo-randomized sequence of nozzles contribute to the fillings of openings among the interlaced sub-arrays and thus the peculiar ejection characteristics of any one given nozzle do not become dominant in any one general area of the LCD panel but are instead blended with the characteristics of other nozzles so as to create an appearance of greater uniformity of optical characteristics across the panel.

A second method of manufacturing a color filter substrate-by using a print head unit ejecting color inks includes forming a light blocking layer defining a plurality of openings on a base substrate, first discontinuously ejecting the color inks into the spaced-apart openings parts without bridging over the separation barriers between the openings and second continuously ejecting the color inks into the openings so as to bridge the inks over the separation barriers between the openings. This bridging of the inks over the separation barriers between immediately adjacent openings tends to provide more planar tops and less domed shapes in the individual openings due to adhesion of the inks to the bridging surfaces. The second method may be combined with the first method.

According to the here disclosed methods of manufacturing the color filter substrate, persistent color spots that would otherwise be generated due to persistent idiosyncrasies of individual nozzles of the print head are prevented, and the undesirable colorspots are prevented from being displayed or at least reduced in there prominence. Performance and quality of the color filter substrate are improved by uniformizing the refracting characteristics of the color filters across the panel. Therefore, color reproducibility and display quality improves.

### BRIEF DESCRIPTION OF THE DRAWINGS

The above and other aspects of the disclosure will become clearer by reference to the following detailed description when considered in conjunction with the accompanying drawings wherein:

FIG. 1 is a perspective view illustrating a manufacturing apparatus that may be used for mass production of a color filter in accordance with one embodiment;

FIG. 2 is a flow-chart illustrating a method of manufacturing a color filter in accordance with a first exemplary embodiment;

FIGS. 3A to 3F and FIGS. 4A and 4B are plan views illustrating a method of manufacturing a color filter in FIG. 2;

FIG. 5 is a flow-chart illustrating a method of manufacturing a color filter in accordance with a second exemplary embodiment;

FIGS. 6 and 7 are plan views illustrating a first ejecting step in accordance with another embodiment;

FIGS. 8A and 8B and FIGS. 9A and 9B are plan views illustrating a second ejecting in FIG. 5;

FIG. 10 is a plan view illustrating a color filter substrate in FIG. 5; and

FIG. 11 is a cross-sectional view taken along a line I-I′ of FIG. 10.

### DETAILED DESCRIPTION

Embodiments provided in this disclosure are exemplary and do not limit the scope of invention. In the drawings, the size and relative sizes of layers and regions may be exaggerated for clarity and are therefore not necessarily to scale.

It will be understood that when an element or layer is referred to as being “on”, “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like numbers generally refer to like elements throughout. As used herein, the term “and/or” includes any and all combinations of one or more of the associated listed items.

It will be understood that, although the terms first, second, third etc. may be used herein to describe various elements, components, regions, layers and/or sections, these elements, components, regions, layers and/or sections should not be limited by these terms. These terms are generally used to distinguish one element, component, region, layer or section from another region, layer or section. Thus, a first element, component, region, layer or section discussed below could be termed a second element, component, region, layer or section without departing from the teachings of the disclosure.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

Embodiments described herein with reference to cross-section illustrations that are often schematic illustrations of idealized embodiments (and intermediate structures). As such, variations from the shapes of the illustrations as a result, for example, of manufacturing techniques and/or tolerances, are to be expected. Thus, the disclosure should not be construed as limited to the particular shapes of regions illustrated herein but is to be seen as including routine deviations in shapes that result, for example, from manufacturing.

Unless otherwise defined, all terms (including technical and scientific terms) used herein have the ordinary meaning as commonly understood by one of ordinary skill in the art to which this disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

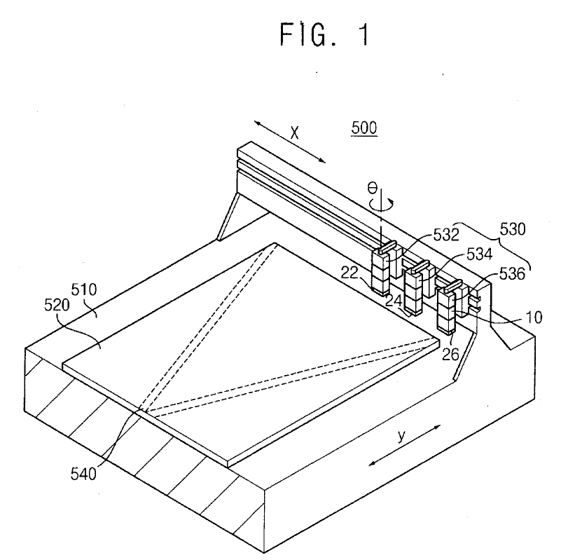

FIG. 1 is a perspective view illustrating a manufacturing apparatus for a color filter in accordance with one embodiment.

Referring to FIG. 1, a color filter manufacturing apparatus 500 includes an apparatus base 510, a movable stage 520, a print head unit 530 and a rotation cross part 540.

The moveable stage 520 is disposed on the apparatus base 510 and a plurality of color filter substrates (not shown) may be sequentially attached to and removed from the stage 520 by automatic or manual means as mass production proceeds. The rotation cross part 540 is disposed under the moveable stage 520, and may be used to rotate the stage 520 into different angular orientations relative to orientations of print heads 532, 534 and 536. In one embodiment, the print head unit 530 moves the print heads 532, 534 and 536 in an X direction of the apparatus base 510 while the moveable stage 520 translates a substrate disposed thereon a Y direction that is substantially perpendicular to the X direction so that the print heads 532, 534 and 536 can effectively scan across the substrate in the Y direction due to Y reciprocation of the stage and so that the print heads 532, 534 and 536 can effectively scan across the substrate in the X direction due to X reciprocation of the print head unit 530.

The illustrated print head unit 530 includes a first print head 532, a second print head 534 and a third print head 536 each corresponding to a different ink supply (i.e., different colors of ink). While the print head unit 530 moves in the X direction in one embodiment, the first, second and third print head units 532, 534 and 536 may nonetheless move independently from each other. In an alternate embodiment, the first, second and third print head units 532, 534 and 536 move together integrally.

For the embodiment where the first, second and third print head units 532, 534 and 536 move independently from each other, for example, each of the first, second and third print head units 532, 534 and 536 may include a respective θ axis rotation motor (not specifically shown) for rotating the corresponding print head about the Z-axis (orthogonal to X and Y) to a desired angular orientation. Thus each independently moveable print head may move in independently the X direction and also rotate independently in the θ angular direction.

For the embodiment where the first, second and third print head units 532, 534 and 536 move together integrally, the collection of the first, second and third print head units 532, 534 and 536 move together in the X direction, and they rotate together in the θ angular direction as an integral unit.

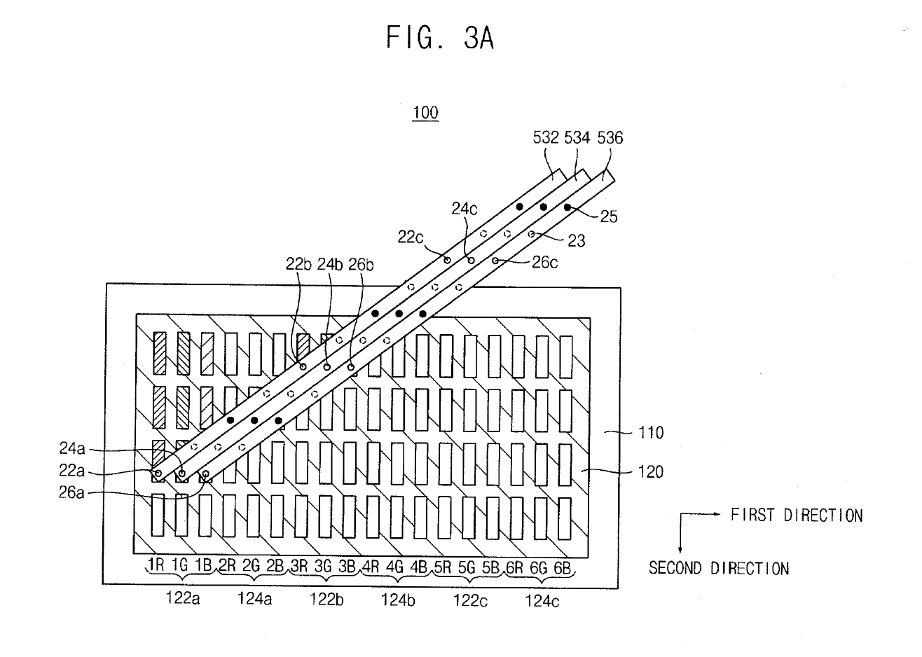

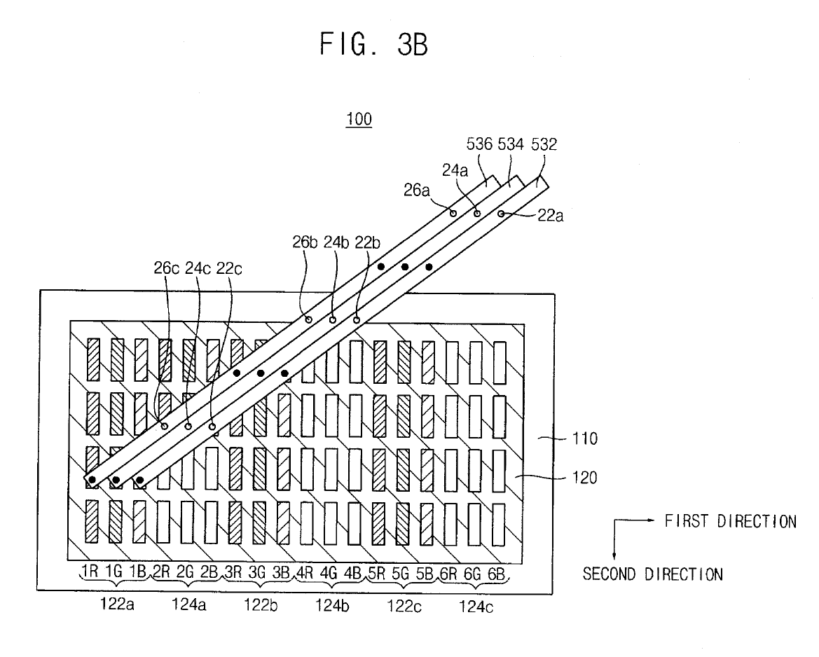

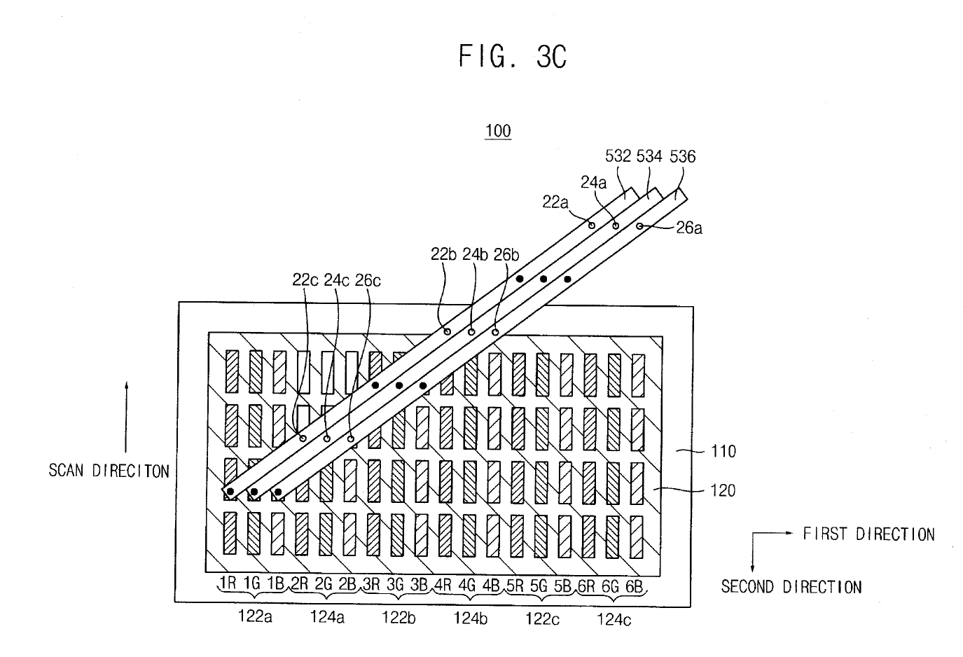

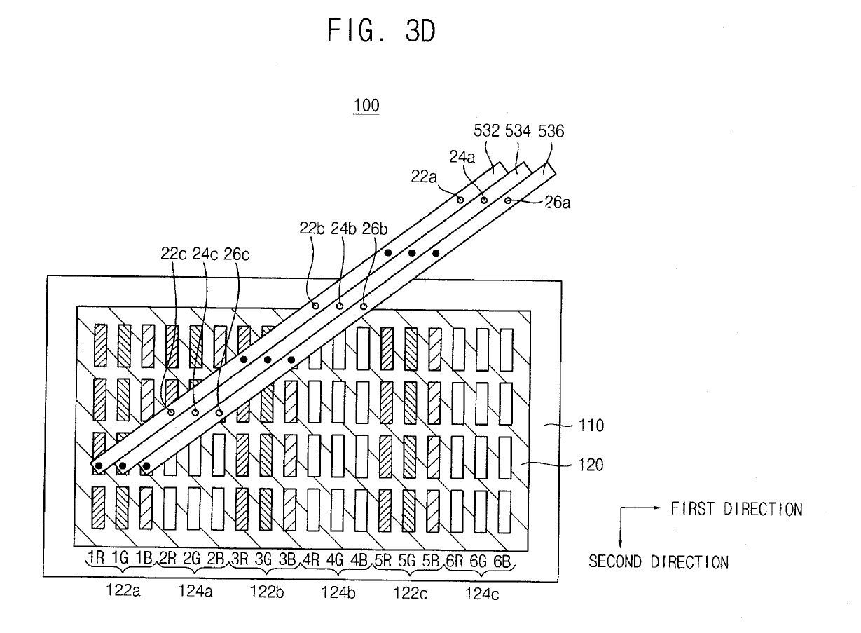

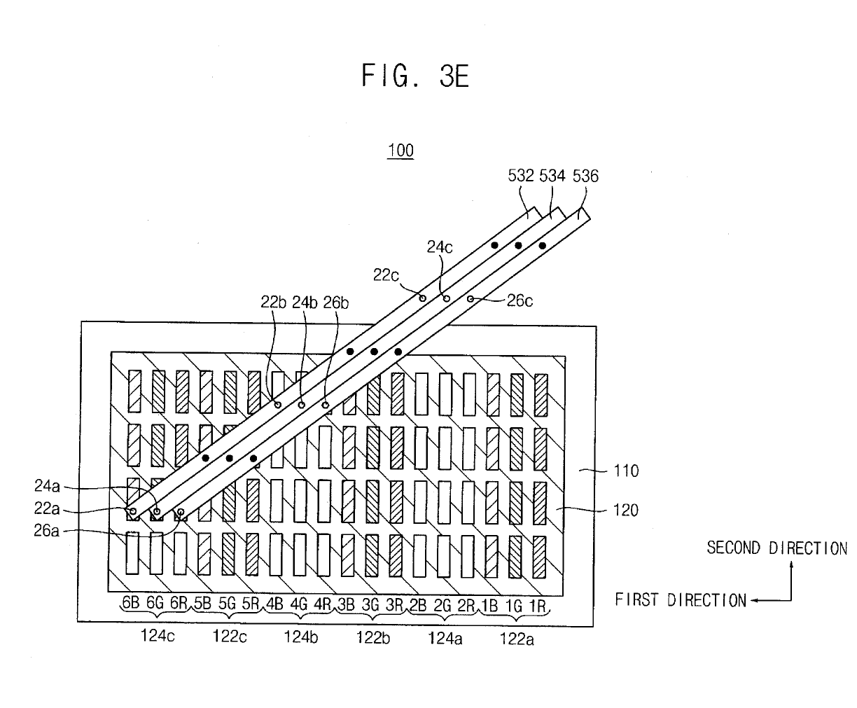

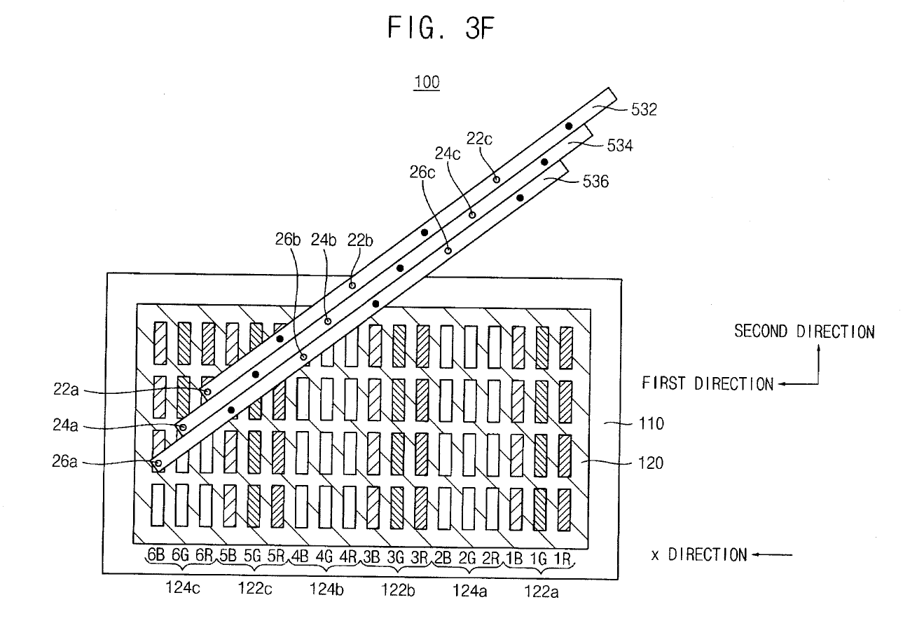

The first print head 532 includes a first multi-nozzle ejector 22, and the second print head 534 includes a second multi-nozzle ejector 24. The third print head 536 includes a third multi-nozzle ejector 26. Individual nozzles of the multi-nozzle ejectors 22, 24 and 26 may be better seen in FIG. 3A for example. In one embodiment, the first, second and third print heads 532, 534 and 536 respectively eject a first color ink, a second color ink and a third color ink having different colors from each other. For example, the first print head 532 may eject a red color ink, and the second print head 534 may eject a green ink. The third print head 536 may eject a blue color ink.

Generally, a predefined pitch between the openings of a given color filter substrate does not coincide with a predefined pitch between the ejecting nozzles of the print heads. However, by changing the angular orientation of the print heads it is possible to create a match between the spacing of the at least some of the nozzles as measured along a first direction and the pitch of the openings. When a supplied color filter substrate is disposed on the stage in the space between the print head unit 530 and the stage 520, the first, second and third print heads 532, 534 and 536 may be moved in the X direction and/or they may be rotated in the θ direction so as to cause the openings formed on the color filter substrate to correspond with the first, second and third print heads 532, 534 and 536. The rotation cross part 540 may additionally or alternatively be used in order to change a corresponding position between the print head unit 530 and the color filter substrate.

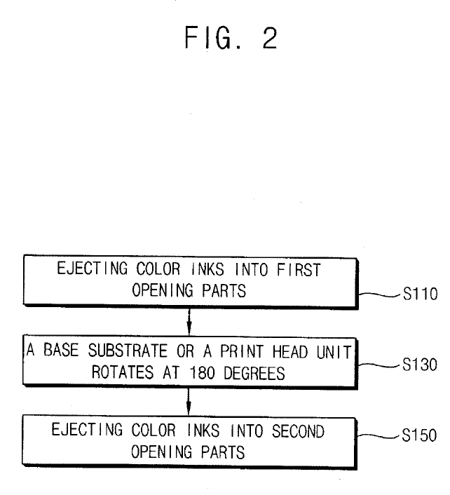

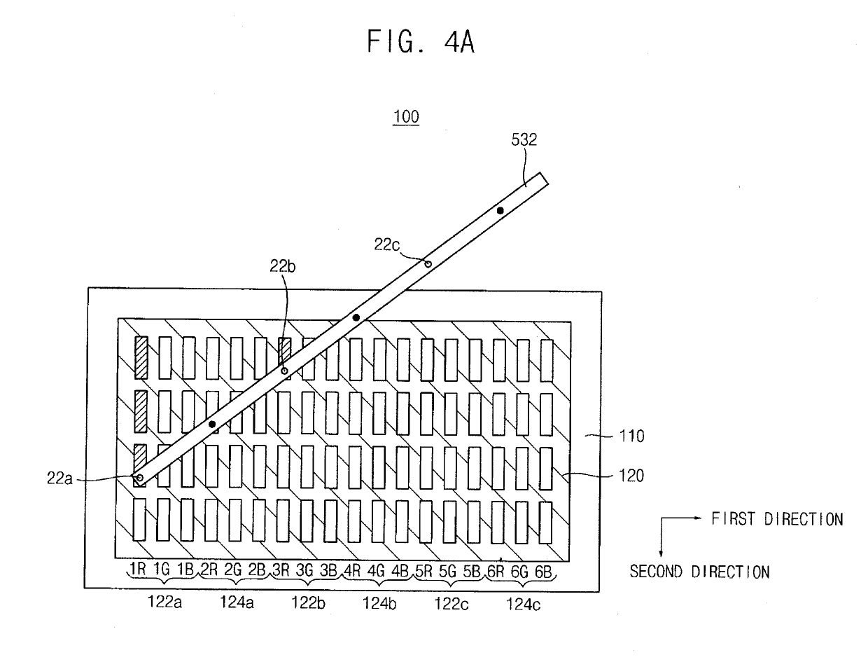

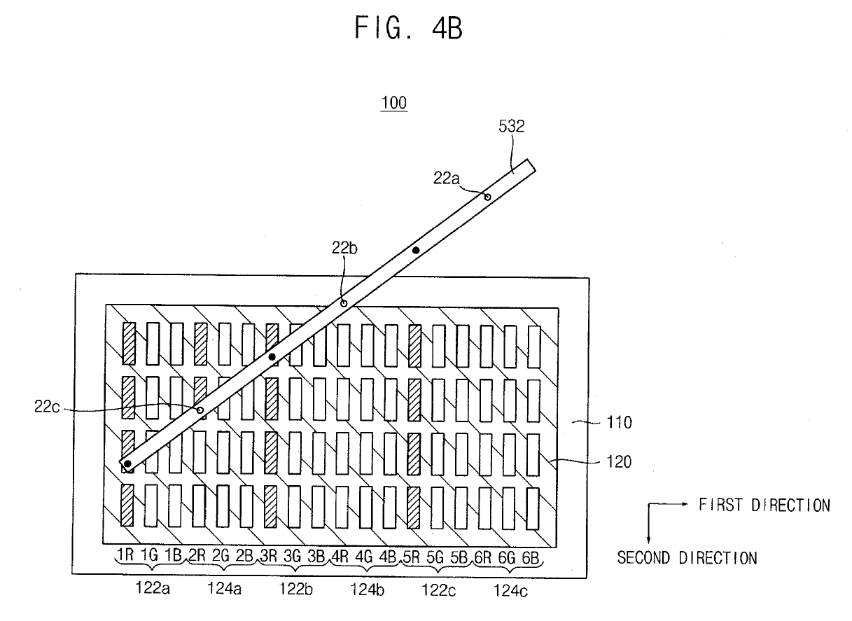

Referring to FIG. 2, a flow-chart illustrates a first method of manufacturing a color filter in accordance with the disclosure. FIGS. 3A to 3F and FIGS. 4A and 4B are plan views illustrating a method of manufacturing a color filter using the method flow charted in FIG. 2.

Referring to FIG. 2, the matrix of light passage openings into which the color filter inks are to be added is divided into at least a first sub-array of openings (which sub-array is at times referred to herein as the first opening parts) and a second sub-array of openings (which sub-array is at times referred to herein as the second opening parts) where the first and second sub-arrays are interlaced with one another. More specifically, in FIG. 3A; the odd-numbered sets of vertical columns: 1R-1G-1B, 3R-3G-3B, 5R-5G-5B, etc. define a first sub-array into which inks are being applied in the step depicted by FIG. 3A while the even-numbered sets of vertical columns: 2R-2G-2B, 4R-4G-4B, 4R-4G-6B, etc. define a second sub-array into which inks are selectively not being applied in the step depicted by FIG. 3A. FIG. 3A corresponds to step S-110 of FIG. 2 wherein the print head units are in a first angular orientation (note that head 532 is topmost in FIG. 3A) and the print head units are ejecting color inks into only the first opening parts (the first sub-array of openings as defined by braces 122a, 122b, 122c).

Next, in step S-130 of FIG. 2; either one or both of the base substrate and the print head unit rotates by 180 degrees so that, as seen in FIG. 3B, for the case of rotation as a whole unit, head 532 is now the bottommost instead of the topmost as it was in FIG. 3A. This 180 degree change of angular rotation brings nozzles 22c, 24c, 26c into scanning alignment over braced column 124a. Note that earlier, in FIG. 3A these same nozzles, 22c, 24c, 26c, were instead in scanning alignment over braced column 122c.

Next, in step S-150 of FIG. 2; with the print head units in their second angular orientation and with the alignment of the nozzles relative to the matrix of openings having been reshuffled, the print head units are selectively activated to eject appropriate color inks only into the second sub-array of openings (the second opening parts). Thus, color filters are formed in a manner where the alignment of the nozzles relative to the matrix of openings does not remain fixed but instead is reshuffled at least once so as to thereby provide a pseudo-random correspondence between specific ones of the nozzles (which specific nozzles may have individual ink ejecting characteristics or idiosyncrasies) and interlaced groups of openings. Rotating the print head units may include rotating independently each of the print head units in each of their individual rotation axes, and/or it may include rotating the entire collection of the print head units in one rotation axis, integrally. Additionally or alternatively, the angular relation between the print heads and the substrate may be changed by rotating the base stage.

When the print head units eject the color inks into the second opening parts after the entirety of the print head units had rotated integrally in one rotation axis or when the base substrate rotates after the entire of the print head units rotate integrally in the rotation axis, the arrangement of the base substrate and the print head units may not coincide for scanning purposes. Thus, it might be necessary to calibrate the positions of the base substrate relative to the colors of inks in the print head units or to switch the colors supplied to the print heads after each rotation.

Hereinafter, forming a red color filter, a green color filter and blue color filter will be explained in more detail with reference to FIGS. 3A to 3F, and forming a red color filter, a green color filter and blue color filter in sequence will be explained with reference to FIGS. 4A to 4B.

FIG. 3A is a plan view illustrating how to eject each color inks into the first sub-array openings by use of the first print head 532, the second print head 534 and the third print head 536 having their longitudinal axes disposed at a first angular orientation relative to a supplied substrate.

Referring to FIG. 3A, a corresponding relationship between the first, second and third print heads 532, 534 and 536 and a plurality of openings is illustrated in FIG. 3A. Each ejecting nozzle of the print heads 532, 534 and 536 is disposed correspondingly to each of the openings, respectively.

A color filter substrate 100 is supplied with a light blocking layer 120 formed on a base substrate 110, where the light blocking layer 120 has a plurality of openings defined in it. The openings are formed as an M*N matrix. The illustrated number is merely an example and more typically there will be many hundreds or thousands of such openings as opposed to the illustrated matrix of 4 openings per individual column and 8 times 3 as a number of such individual columns. Thus the light blocking layer 120, for example, may include a plurality of openings as the illustrated 18*4 matrix. Rows of openings are arranged in a first direction which is a horizontal direction of the illustrated M*N matrix. Columns of openings are organized along the second direction which is the vertical direction of the illustrated M*N matrix. For example, first opening columns 1R, 2R, 3R, 4R, 5R and 6R, second opening columns 1G, 2G, 3G, 4G, 5G and 6G and third opening columns 1B, 2B, 3B, 4B, 5B and 6B are arranged one after the other in the first direction, in the illustrated sequence.

The combination of the first individual openings column, 1R and the second individual openings column 1G, and the third individual openings column 1B is represented as a first part 122a of a first sub-array of openings (a first opening parts) 122a, 122b and 122c each having odd-numbered individual columns. The combination of the second individual openings column, 2R, the second individual openings column, 2G, and third individual openings column, 2B is represented as a first part 124a of a second sub-array of openings (a second opening parts) 124a, 124b and 124c. each having even-numbered individual columns.

The red openings 1R, 2R, 3R, 4R, 5R and 6R are aligned correspondingly to first ejecting nozzles 22a, 22b and 22c of the first print head 532, respectively. The green openings 1G, 2G, 3G, 4G, 5G and 6G are aligned corresponding to second ejecting nozzles 24a, 24b and 24c of the second print head 534, respectively. The blue openings 1B, 2B, 3B, 4B, 5B and 6B are corresponding to third ejecting nozzles 26a, 26b and 26c of the third print head 536, respectively.

The first print head 532 may further include a set of currently non-discharging nozzles 23 (schematically shown as dashed circles) disposed between the first nozzle 22a and the second nozzle 22b. The first print head 532 may further include a set of currently non-discharging nozzles 25 (schematically shown as dark-filled circles) disposed correspondingly to the second sub-array of openings 124a, 124b and 124c. The first print head 532 may be selectively configured to include the currently non-discharging nozzles 23 and 25 for the purpose of synchronizing the spacing between its currently ejecting nozzles to a pitch between the openings of the supplied substrate. The second and third print heads 534 and 536 may similarly include second and third currently ejecting nozzles 24a, 24b, 24c, 26a, 26b and 26c, and may further include selectively non-discharging nozzles 23 and 25 for substantially the same reason as the non-discharging nozzles of the first print head are provided as mentioned above.

In one embodiment, a print head unit of the tradename, SPECTRA SE-128® (manufactured by SPECTRA Co., U.S.A.) is used and this particular print head unit includes one hundred twenty eight (128) individual ink ejecting nozzles. In one embodiment (not shown), sixty four (64) of the one hundred twenty eight ejecting nozzles are configured to correspond alignably to a first sub-array of openings (32 individual columns) and to a second sub-array of openings (32 individual columns), respectively while the remaining sixty four nozzles are temporarily configured as non-discharging nozzles so as to thereby synchronize the pitch with the horizontal pitch of openings in a given substrate.

Thus, among the sixty four ejecting nozzles corresponding to the first and second opening parts, a portion of the ejecting nozzles corresponding to the first opening parts are selectively configured (by computer program or other automated means) as discharging nozzles, and remaining portion of the ejecting nozzles corresponding to the second opening parts are configured as non-discharging nozzles, so that color inks can be selectively ejected into one or the other of the first opening parts (first sub-array) and the second opening parts (second sub-array) independently.

In a first scan run in the vertical direction, the first print head 532 ejects red color ink into the first, third and fifth individual columns of openings 1R, 3R and 5R

Simultaneously, the second print head 534 ejects green color ink into the first, third and fifth sub openings 1G, 3G and 5G and the third print head 536 ejects blue ink into the first, third and fifth sub openings 1B, 3B and 5B.

Therefore, red color filters are formed by ejecting the red color ink into the odd-numbered first openings 1R, 3R, and 5R, and green color filters are formed by ejecting the green color ink into the odd-numbered second openings 1G, 3G, and 5G. The blue color filters are similarly formed in the first scan (before rotation) by ejecting the blue color ink into the odd-numbered third openings 1B, 3B, and 5B. FIGS. 3B to 3F are plan views illustrating how to eject different color inks into the second sub-array (the second opening parts) by using the same first, second and third print heads.

When the print head unit rotates in one rotation axis by 180 degrees, or the print heads rotate simultaneously together even if each of the print heads has an independent rotation axis, the first nozzles of the first print head filled with the red color ink correspond to the third openings of the second opening parts, respectively. Therefore, the red color filters may be formed in positions originally designated as those of the blue color filters.

In one embodiment, in order to calibrate the positions after rotation, the color inks filled into the first print head and the third print head are changed, or positions of the first and third print heads are directly changed so as to realign the red ink with the columns designated as red and the blue ink with the columns designated as blue.

As one example method of calibrating the positions mentioned above, the first, second and third print heads rotate in one axis, and the blue color ink is filled in the first print head after the red color ink having been earlierfilled in the first print head, and the red color ink is filled in the third print head after the blue color ink having been earlier filled in the third print head.

When the red color ink is filled in the first print head discharging the red color ink into the first openings, the red color ink filled in the first print head is removed, and the blue color ink is filled into the first print head. When the blue color ink is filled in the third print head, the blue color ink is removed from the third print head, and the red color ink is filled in the third print head.

As another example method of fixing the positions, the blue color ink is filled into the first print head after the red color ink being filled in the first print head, and the first, second and third print heads 532, 534 and 536 may rotate in one axis.

Referring to FIG. 3B, the first print head 532 is now filled with the blue color ink, and ejects the blue color ink into the second, fourth and sixth sub openings 2B, 4B and 6B of the third openings 1B, 2B, 3B, 4B, 5B and 6B of the second opening parts 124a, 124b and 124c. The third print head 536 is now filled with the red color ink, and ejects the red color ink into the second, fourth and sixth sub openings 2R, 4R and 6R of the first openings 1R, 2R, 3R, 4R, 5R and 6R of the second opening parts 124a, 124b and 124c.

Therefore, the first nozzle of the first ejecting nozzle 22a ejects the red color ink into the sixth sub opening 6R of the first openings 1R, 2R, 3R, 4R, 5R and 6R of the third part 124c of the second opening parts 124a, 124b and 124c, after ejecting the red color ink into the first sub opening 1R of the first openings 1R, 2R, 3R, 4R, 5R and 6R of the first part 122a of the first opening parts 122a, 122b and 122c through the first nozzle 22a of the first ejecting nozzles 22a, 22b and 22c. The third of the first ejecting nozzle 22c ejects the red color ink into the fifth sub opening 5R of the first openings 1R, 2R, 3R, 4R 5R and 6R of the first opening part 124a, after ejecting the red color ink into the second sub opening 2R of the first openings 1R, 2R, 3R, 4R, 5R and 6R of the first part 124a of the second opening parts 124a, 124b and 124c through the third nozzle of the first ejecting nozzles 22a, 22b and 22c.

An ejecting nozzle of not only the first print head 532, but also the second and third print heads 534 and 536 eject a color ink into the first opening of the second opening part after the second and third print heads 534 and 536 ejecting a color ink into a last opening. The second print head 534 filled with the green color ink ejects the green color ink into the second, fourth and sixth openings 2G, 4G and 6G of the second openings 1G, 2G, 3G, 4G, 5G and 6G of the second opening parts 124a, 124b and 124c even if the second print head 534 rotates in one axis at about 180 degrees.

The print head ejecting the color ink into the first opening parts rotates and ejects the color ink into the second opening parts, so that uniformity of amounts of the color inks ejected by each individual one of the ejecting nozzles may improve due to pseudo-random reorganization of the nozzles between one selective scan and a next interlaced scan. The color filters formed by the same ejecting nozzle are disposed psuedo-randomly as a result, so that total uniformity of the color filters across the large area of the color filter substrate may improve.

The red, green and blue color filters are formed in the light blocking layer 120 having the openings formed as an 18*4 matrix in the example as mentioned above. As M, N of an M*N matrix are increased, the uniformity of the color filters may further improve.

As another example method of calibrating the positions mentioned above, the first print head 532 filled with the red color ink and the third print head 536 filled with the blue color ink are switched from each other and eject the color inks.

Referring to FIG. 3C, positions of the first and third print heads 532 and 536 are switched from each other, and the first print head may eject the red color ink into the second, fourth and sixth sub openings 2R, 4R and 6R of the first openings 1R, 2R, 3R, 4R, 5R and 6R of the second opening parts 124a, 124b and 124c. Moreover, the third print head may eject the blue color ink into the second, fourth and sixth sub openings 2B, 4B and 6B of the third openings 1B, 2B, 3B, 4B, 5B and 6B of the second opening parts 124a, 124b and 124c.

The color inks may be ejected into the second opening parts 124a, 124b and 124c in an opposite direction (180 degrees) to what is illustrated as being the second direction. For example, a scan direction of the print head unit may be the opposite direction to the second direction. The color inks are ejected into the first opening parts 122a, 122b and 122c in the second direction.

Ejecting the color inks into the second opening parts 124a, 124b and 124c in the second direction is illustrated in FIG. 3B, and ejecting the color inks into the second opening parts 124a, 124b and 124c but in the opposite direction to second direction is illustrated in FIG. 3C. The scan direction of the print head unit may be any direction among the second direction and the opposite direction to the second direction. Each ejecting directions of the color inks may be different from each other in forming the color filters, so that the pseudo-randomness of distribution with respect to the specific nozzles used and the specific scan direction used for ejecting inks into the openings is increased and the apparent uniformity of the hardened color filters of the color filter substrate may further improve.

FIG. 3D is a plan view illustrating a process wherein the first, second and third print heads include independent rotation axes and rotate with respect to each of the independent rotation axes to eject the color inks into the second opening parts, respectively.

Referring to FIG. 3D, when each of the first, second and third print heads 532, 534 and 536 respectively rotates independently with respect to its independent axis of rotation, the first print head 532 may correspond to the second, fourth and sixth sub openings 2R, 4R and 6R of the first openings 1R, 2R, 3R, 4R, 5R and 6R of the second opening parts 124a, 124b and 124c. The second print head 534 may correspond to the second, fourth and sixth sub openings 2G, 4G and 6G of the second openings 1G, 2G, 3G, 4G, 5G and 6G of the second opening parts 124a, 124b and 124c, and the third print head 536 may correspond to the second, fourth and sixth sub openings 2B, 4B and 6B of the third openings 1B, 2B, 3B, 4B, 5B and 6B of the second opening part 124a, 124b and 124c.

Therefore, the first nozzle 22a of the first ejecting nozzles 22a, 22b and 22c ejects the red color ink into the sixth sub opening 6R of the first openings 1R, 2R, 3R, 4R, 5R and 6R of the second opening parts 124a, 124b and 124c to form a red color filter, and the first nozzle 22a of the first ejecting nozzles 22a, 22b and 22c ejects the red color ink into the first sub opening 1R of the first openings 1R, 2R, 3R, 4R, 5R and 6R of the first opening parts 122a, 122b and 122c as substantially the same process as in FIG. 3C. The second and third print head 534 and 536 eject the green and blue color inks into the second opening parts 124a, 124b and 124c, respectively, so that the color filter is formed to have totally uniform distribution of the color filter substrate.

As illustrated in FIG. 3D, when the first, second and third print heads 532, 534 and 536 respectively rotate with respect to each of the rotation axes, a result of a process illustrated in FIG. 3D is substantially the same as a result of a process illustrated in FIG. 3C, consequentially. In the process illustrated in FIG. 3C, the first print head 532 filled the red color ink changes a position with the third print head 536 filled the blue color ink and the first, second and third print head 532, 534 and 536 rotate with respect to one rotation axis.

FIGS. 3E and 3F are plan views illustrating a process that the color inks are ejected into the first opening parts and the base substrate rotates to eject the color inks into the second opening parts.

When the base substrate rotates, a step of calibrating the position with the inks supplied to the respective print heads may be also required as substantially the same when the first, second and third print heads integrally rotate with respect to the rotation axis. The blue color filter is formed at the first opening that may correspond to the red color filter, and the red color filter is formed at the third opening that may correspond to the blue color filter.

Therefore, the step of calibrating the position is required, the step of calibrating the position of the opening parts may include changing the color inks filled into the first and third print heads or may include changing positions of the first, second and third print heads in the X direction and rearranging the positions of the first, second and third print heads.

Referring to FIG. 3E, as one example method of calibrating the position, the blue color ink is filled into the first print head 532, and the red color ink is filled into the third print head 536.

Therefore, the third print head 536 filled with the red color ink corresponds to the sixth sub opening 6R of the first openings 1R, 2R, 3R, 4R, 5R and 6R of the third part 124c of the second opening parts 124a, 124b and 124c, and the red color ink may be ejected into the sixth sub opening 6R of the first openings 1R, 2R, 3R, 4R, 5R and 6R of the third part 124c of the second opening parts 124a, 124b and 124c. The first print head filled with the blue color ink corresponds to the sixth sub opening 6B of the third openings 1B, 2B, 3B, 4B, 5B and 6B of the third part 124c of the second opening parts 124a, 124b and 124c, and the blue color ink may be ejected into the sixth part 6B of the third openings 1B, 2B, 3B, 4B, 5B and 6B of the third part 124c of the second opening parts 124a, 124b and 124c.

Referring to FIG. 3F, as another example method of calibrating the position, the base substrate rotates at about 180 degrees, and the positions of first, second and third print heads in the X direction are changed and rearranged.

When the first, second and third print heads 532, 534 and 536 may respectively and independently move in the X direction, the first, second and third print heads 532, 534 and 536 respectively and independently move in the X direction, and rotate along the rotation axis, so that the red, green and blue color filters may be formed at the second opening parts 124a, 124b and 124c.

FIG. 4A is a plan view illustrating a process that a print head unit for ejecting one color ink ejects the one color ink into the first opening parts. FIG. 4B is a plan view illustrating a process that a print head unit for ejecting one color ink ejects the one color ink into the second opening parts.

Referring to FIG. 4A, the first print head 532 ejects the red color ink into only the first, third and fifth sub openings 1R, 3R and 5R of the first openings 1R, 2R, 3R, 4R, 5R and 6R of the first opening parts 122a, 122b and 122c when moving in the second direction.

The first print head 532 ejecting the red color ink is illustrated as an example in FIG. 4A. The second print head 534 may eject the green color ink into the first, third and fifth sub openings 1G, 3G and 5G of the second openings 1G, 2G, 3G, 4G, 5G and 6G of the first opening parts 122a, 122b and 122c. The third print head 536 may eject the blue color ink into the first, third and fifth sub openings 1B, 3B and 5B of the third openings 1B, 2B, 3B, 4B, 5B and 6B of the first opening parts 122a, 122b and 122c.

As illustrated in FIG. 4A, the red color ink is ejected, and the green color ink is ejected by the second print head 534, and the blue color ink is ejected by the third print head 536, in sequence. The above-described processes are determined by chemical characteristics of the color inks and a repulsive force between the color inks and the light blocking layer.

In the step of ejecting the color inks into the first opening parts 122a, 122b and 122c, the first print head 532 ejects the red color ink into the first opening part 122a, 122b and 122c, and then the second print head 534 ejects the green color ink into the first opening parts 122a, 122b and 122c. The third print head 536 then ejects the blue color ink into the first opening parts 122a, 122b and 122c. Therefore, the red, green and blue color filters may be formed.

Referring to FIG. 4B, the first print head 532 rotates with respect to the rotation axis, and then the red color ink is ejected into the second opening parts 124a, 124b and 124c.

The first print head 532 rotates so that the third nozzle 22c of the first ejecting nozzles 22a, 22b and 22c corresponds to the second sub opening 2R of the first openings 1R, 2R, 3R, 4R, 5R and 6R of the first part 124a of the second opening parts 124a, 124b and 124c, and the second nozzle 22b of the first ejecting nozzles 22a, 22b and 22c corresponds to the fourth sub opening 4R of the first openings 1R, 2R, 3R, 4R, 5R and 6R of the second part 124b of the second opening parts 124a, 124b and 124c. The first nozzle 22a of the first ejecting nozzles 22a, 22b and 22c corresponds to the sixth sub opening 6R of the first openings 1R, 2R, 3R, 4R, 5R and 6R of the third part 124c of the second opening parts 124a, 124b and 124c.

The first print head 532 ejecting the red color ink is illustrated as an example in FIG. 4B. The second print head 534 may eject the green color ink into the second, fourth and sixth sub openings 2G, 4G and 6G of the second openings 1G, 2G, 3G, 4G, 5G and 6G of the second opening parts 124a, 124b and 124c. The third print head 536 may eject the blue color ink into the second, fourth and sixth sub openings 2B, 4B and 6B of the third openings 1B, 2B, 3B, 4B, 5B and 6B of the second opening parts 124a, 124b and 124c.

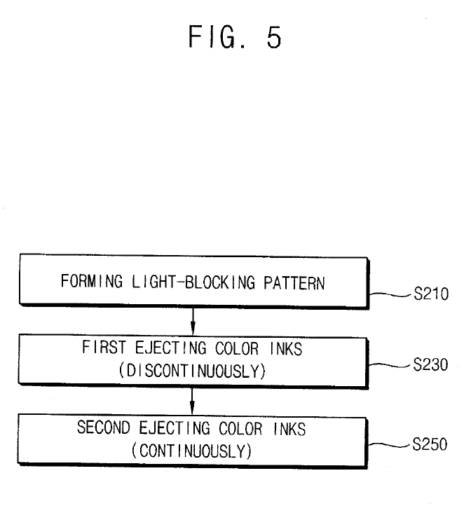

FIG. 5 is a flow-chart illustrating a method of manufacturing a color filter in accordance with a second embodiment of the present invention.

Referring to FIG. 5, a light-blocking pattern having a plurality of opening parts is formed (step S210). Color inks are first ejected into a plurality of the opening parts (step S230). The color inks are second ejected on a base substrate that was first ejected (step S250). Hereinafter, a layer formed by the first ejecting process is referred as a first color layer, and a layer formed on the first color layer by the second ejecting is referred as a second color layer.

In forming the light blocking layer (step S210), an organic ink is printed on the base substrate to form the light blocking layer. Alternatively, the light blocking layer 120 may be formed by another method. A metallic thin film layer such as chrome (Cr) and so on or an organic material group may be deposited by a sputtering method, and may be patterned by a photo-lithography method with a mask to form the light blocking layer 120.

The first ejecting (step S230) may use substantially the same method as the ejecting method of the color inks into the color filter substrate in accordance with the first embodiment. The color inks may be ejected into the first opening parts, and one of the base substrate and the print head unit may rotate relatively. The color ink may be ejected into the second opening parts. As another example, the first ejecting (step S230) may be performed by a normal conventional printing method.

In the first ejecting (step S230), the first, second and third print heads discontinuously eject the red, green and blue color inks into only non-adjacent ones of spaced-apart columns corresponding to the first opening parts and the second opening parts so that same nozzles are not used in adjacent columns during this first step.

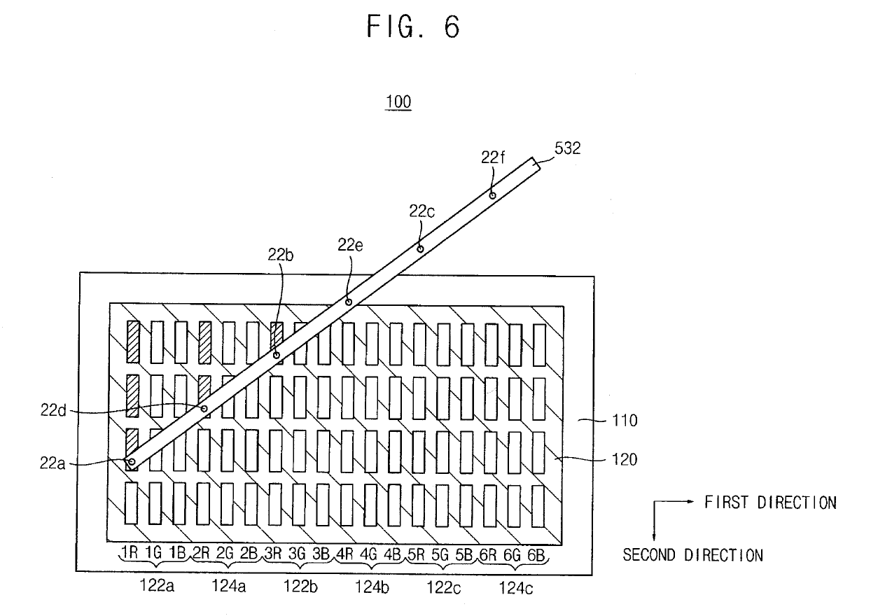

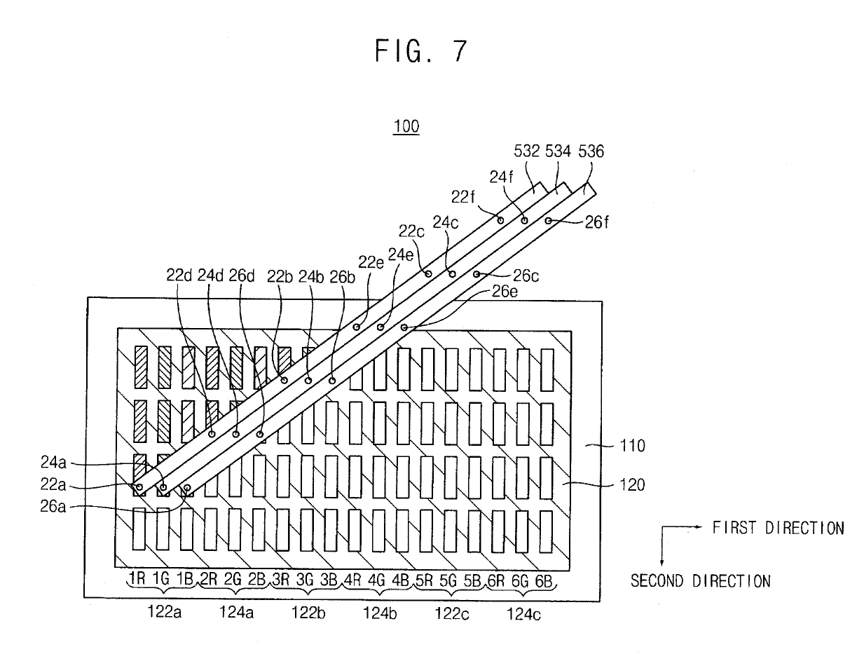

FIGS. 6 and 7 are plan views illustrating a first ejecting in accordance with another embodiment.

Referring to FIG. 6, the first print head 532 is disposed on the first opening parts 122a, 122b and 122c and the second opening parts 124a, 124b and 124c to eject the red color ink. The first print head 532 includes six first nozzles 22a, 22b, 22c, 22d, 22e and 22f ejecting the red color ink. Each of the first ejecting nozzles 22a, 22b, 22c, 22d, 22e and 22f corresponds to each of the first openings 1R, 2R, 3R, 4R, 5R and 6R to eject the red color ink into each of the first openings 1R, 2R, 3R, 4R, 5R and 6R in the second direction.

In the first ejecting (step S230), a part of the first ejecting nozzles may be defined as ejecting nozzles, and a remaining part of the first ejecting nozzles may be selectively defined as non-ejecting nozzles. The red color ink may be ejected into the second opening parts 124a, 124b and 124c after ejecting the red color ink into the first ejecting nozzles.

The first print head 532 filled with the red color ink is explained as one example. The green and blue color inks may be ejected using the second print head filled with the green color ink and the third print head filled with the blue color ink to form the first color layer.

Referring to FIG. 7, each of the print heads corresponds to each of the first, second and third openings 1R, 2R, 3R, 4R, 5R, 6R, 1G, 2G, 3G, 4G, 5G, 6G, 1B, 2B, 3B, 4B, 5B and 6B to eject each of the red, green and blue color ink, respectively, thereby forming the first color layer.

The first print head 532 includes the six first ejecting nozzles 22a, 22b, 22c, 22d, 22e and 22f ejecting the red color ink. The second print head 534 includes six second ejecting nozzles 24a, 24b, 24c, 24d, 24e and 24f ejecting the green color ink. The third print head 536 includes six third ejecting nozzles 26a, 26b, 26c, 26d, 26e and 26f ejecting the blue color ink.

As another example, in the first ejecting (step S230), the color inks may be divisibly ejected into the first opening parts 122a, 122b and 122c and the second opening parts 124a, 124b and 124c to form the first color layer.

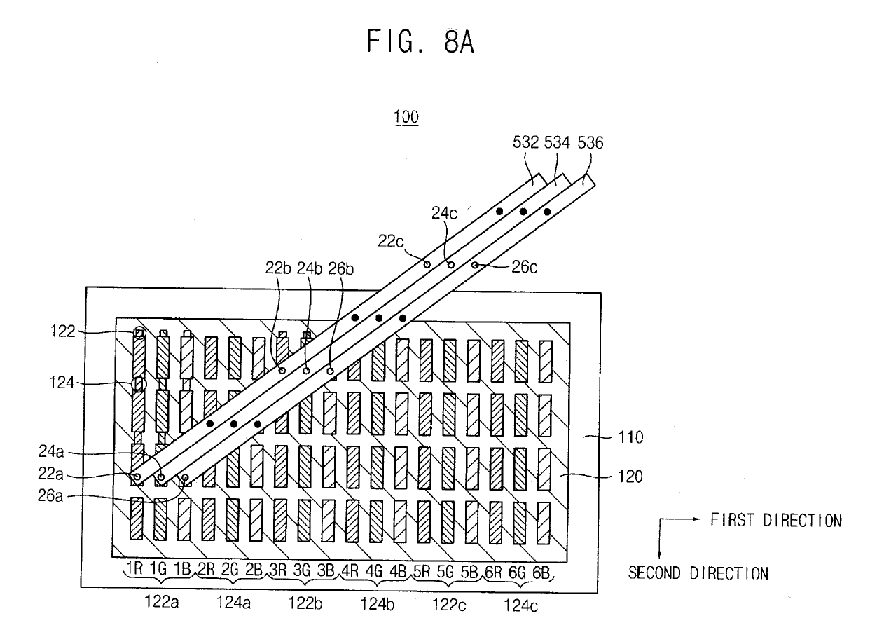

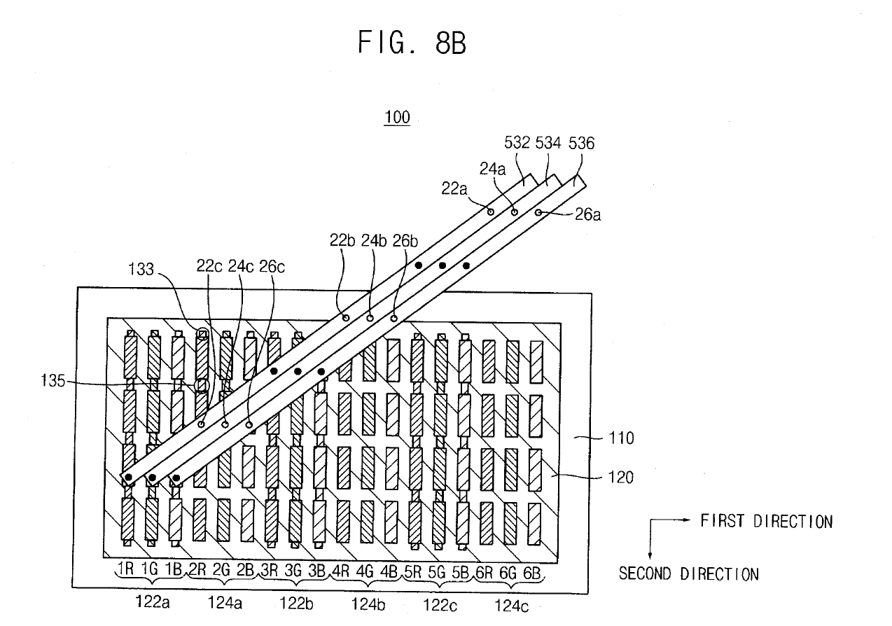

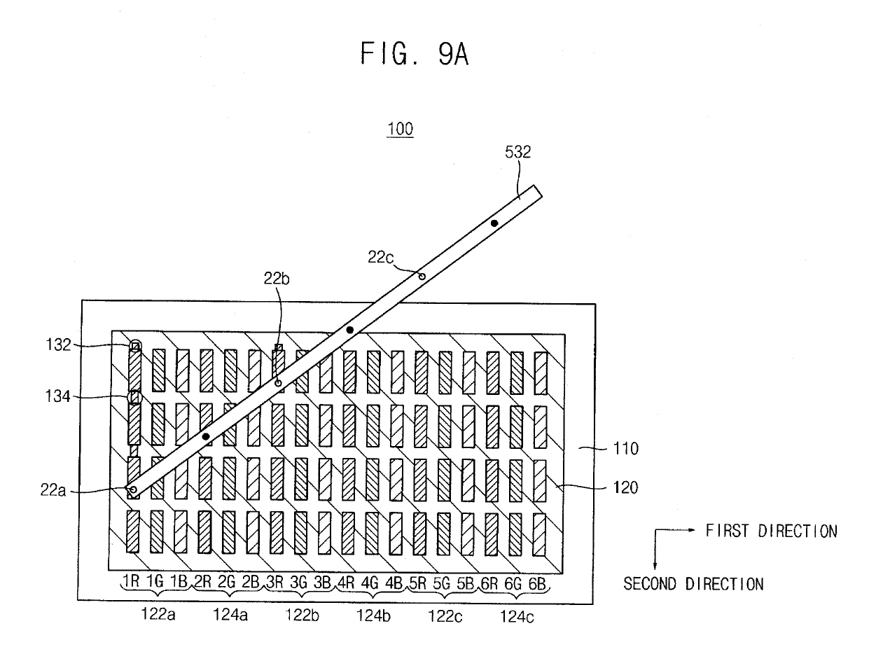

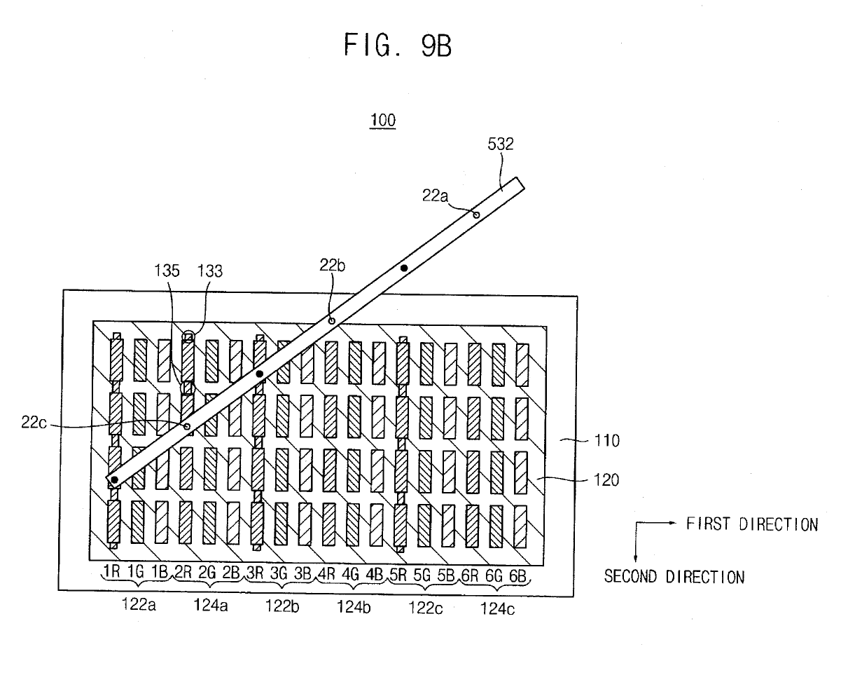

FIGS. 8A and 8B and FIGS. 9A and 9B are plan views illustrating a second ejecting in accordance with a second embodiment.

In the second ejecting (step S250), the first, second and third print head continuously eject the red, green and blue color inks into not only an area corresponding to the first opening parts and the second opening parts but also an area corresponding to a part of the light blocking layer so that continuous lines of ejection are defined by the droplets ejected from the nozzles even over areas where there are no openings so as to thereby create a different adhesion characteristic for those columns that have continuous ejection as opposed to those columns that have discontinuous lines of ejection..

FIGS. 8A and 8B are plan views illustrating a second ejecting using the first, second and third print head 532, 534, 536.

Referring to FIG. 8A, the first print head 532 is disposed on the base substrate 110 having the first color layer to correspond to the first, third and fifth sub openings 1R, 3R and 5R of the first openings 1R, 2R, 3R, 4R, 5R and 6R of the first opening parts 122a, 122b and 122c. The second print head 534 corresponds to the first, third and fifth sub openings 1G, 3G and 5G of the second openings 1G, 2G, 3G, 4G, 5G and 6G of the first opening parts 122a, 122b and 122c. The third print head 536 corresponds to the first, third and fifth sub openings 1B, 3B and 5B of the third openings 1B, 2B, 3B, 4B, 5B and 6B of the first opening part 122a, 122b and 122c of the third print head 536.

The first print head 532 ejects the red color ink into a first light blocking area 132. The first light blocking area 132 is disposed at the first sub opening 1R of the first openings 1R, 2R, 3R, 4R, 5R and 6R of the first part 122a of the first opening parts 122a, 122b and 122c in an opposite direction to the second direction. The red color ink is ejected into the first sub opening 1R of the first openings 1R, 2R, 3R, 4R, 5R and 6R of the first part 122a of the first opening parts 122a, 122b and 122c. The first color layer is formed at the first sub opening 1R of the first openings 1R, 2R, 3R, 4R, 5R and 6R.

The first print head 532 ejects the red color ink into a second light blocking area 134. The second light blocking area 134 is disposed between a side of the first sub opening 1R of the first openings 1R, 2R, 3R, 4R, 5R and 6R and a side of an adjacent first sub opening 1R in the second direction from the first sub opening 1R of the first openings 1R, 2R, 3R, 4R, 5R and 6R of the first part 122a of the first opening parts 122a, 122b and 122c. The first print head 532 ejects the red color ink into the first sub opening 1R of the first openings 1R, 2R, 3R, 4R, 5R and 6R disposed in the second direction from the first sub opening 1R of the first openings 1R, 2R, 3R, 4R, 5R and 6R of the first part 122a of the first opening parts 122a, 122b and 122c to eject the red ink into another second light blocking area 134 between the sides of the first sub openings 1R of the first openings 1R, 2R, 3R, 4R, 5R and 6R.

As mentioned above, the first print head 532 continuously ejects the red color ink into the base substrate 110 having the first color layer in the second direction to form the second color layer on the first opening parts 122a, 122b and 122c, the first light blocking areas 132 and the second light blocking areas 134.

In FIG. 8A, the first print head 532 is illustrated. In addition, the second and third print heads 534 and 536 continuously eject the green and blue color inks in the second direction to form the second color layer on the first opening parts 122a, 122b and 122c, the first light blocking areas 132 and the second light blocking areas 134.

The first, second and third print heads 532, 534 and 536 may rotate, or the base substrate 110 having the first color layer may rotate. In order to rotate the base substrate 110 having the first color layer or to integrally rotate the first, second and third print head 532, 534 and 536 with respect to a rotation axis, the color inks in the print heads or positions of the print heads may change. Alternatively, calibrating position of the print head may be rearranged.

Referring to FIG. 8B, the first print head 532 ejects the red color ink into a third light blocking area 133. The third light blocking area 133 is disposed in an opposite direction to the second direction from the second sub opening 2R of the first openings 1R, 2R, 3R, 4R, 5R and 6R of the first part 124a of the second opening parts 124a, 124b and 124c. The first print head 532 ejects the red color ink into the second sub opening 2R of the first openings 1R, 2R, 3R, 4R, 5R and 6R of the first part 124a of the second opening parts 124a, 124b and 124c including the first color layer.

The first print head 532 ejects the red color ink into a fourth light blocking area 135. The fourth light blocking area 135 is disposed between a side of the second sub opening 2R of the first openings 1R, 2R, 3R, 4R, 5R and 6R and a side of an adjacent second sub opening 2R in the second direction from the second sub opening 2R of the first openings 1R, 2R, 3R, 4R, 5R and 6R of the first part 124a of the second opening parts 124a, 124b and 124c. The first print head 532 ejects the red color ink into the second sub opening 2R of the first openings 1R, 2R, 3R, 4R, 5R and 6R disposed in the second direction from the second sub opening 2R of the first openings 1R, 2R, 3R, 4R, 5R and 6R of the first part 124a of the second opening parts 124a, 124b and 124c to eject the red ink into another fourth light blocking area 135 between the sides of the second sub openings 2R of the first openings 1R, 2R, 3R, 4R, 5R and 6R.

As mentioned above, the first print head 532 continuously ejects the red color inks on the base substrate 110 in the second direction to form the second color layer on the second opening parts 124a, 124b and 124c, the third light blocking areas 133 and the fourth light blocking areas 135.

In FIG. 8B, the first print head 532 is illustrated. In addition, the second and third print heads 534 and 536 continuously eject the green and blue color inks in the second direction to form the second color layer on the second opening parts 124a, 124b and 124c, the third light blocking areas 133 and the fourth light blocking areas 135.

As another example, the first, second and third ejecting nozzles may be used simultaneously as ejecting nozzles using the first, second and third print heads 532, 534 and 536, so that the second color layer may be formed by a single printing process.

FIGS. 9A and 9B are plan views illustrating the second ejecting using the first print head.

Referring to FIG. 9A, the first print head 532 continuously ejects the red color ink on the base substrate 110 having the first color layer to form the second color layer on the first opening parts 122a, 122b and 122c, the first light blocking areas 132 and the second light blocking areas 134.

The first print head 532 rotates and continuously ejects the red color ink on the base substrate 110 having the first color layer, as illustrated in FIG. 9B. Therefore, the second color layer is formed on the second opening parts 124a, 124b and 124c, the third light blocking areas 133 and the fourth light blocking areas 135.

The second and third print heads 534 and 536 may eject the green and blue color inks to form the second color layer substantially the same process as the first ejecting of the red color ink.

A print direction of the first opening parts 122a, 122b and 122c may be substantially the same as a print direction of the second opening parts 124a, 124b and 124c. An opposite direction to the print direction of first opening parts 122a, 122b and 122c may be substantially the same as a print direction of the second opening parts 124a, 124b and 124c.

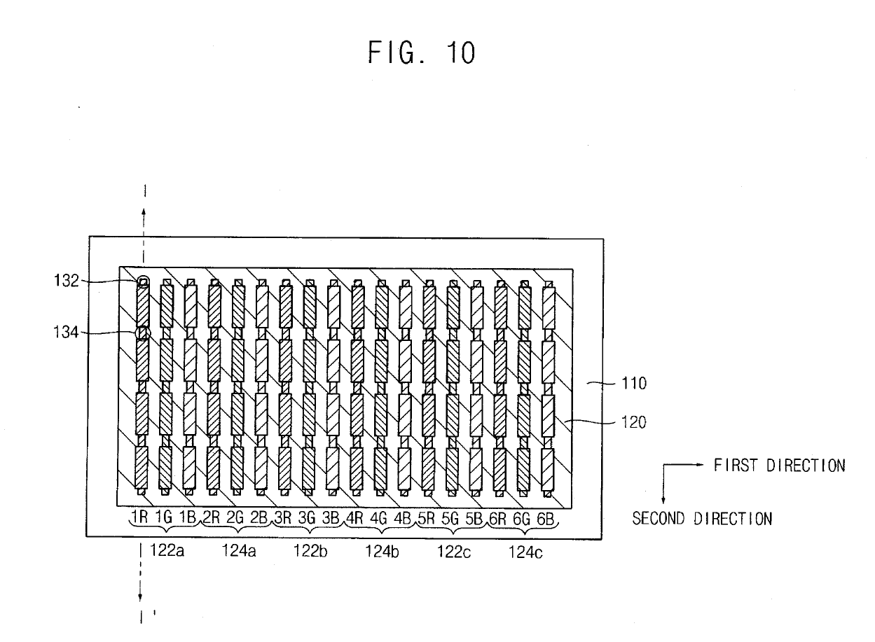

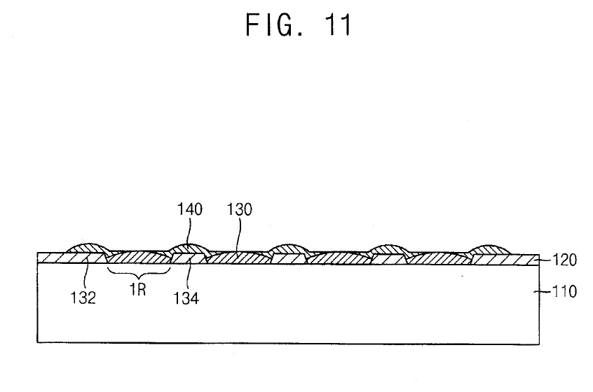

FIG. 10 is a plan view illustrating a color filter substrate in FIG. 5. FIG. 11 is a cross-sectional view taken along a line I-I′ of FIG. 10.

A thickness of the first color layer may not be uniform because of an amount of ejecting color inks and a repulsive force between the color inks and the light blocking layer. In another method of manufacturing printed color filters through forming only the first color layer, uniformity of the color filters may be decreased.

Referring to FIGS. 10 and 11, the second color layer 140 is formed on the base substrate 110 having the first color layer 130. In order to form the first color layer 130 on the base substrate 110 having the first color layer 130, the second color layer 140 may fill a stepped portion between the first color layer 130 and the second light blocking layer 120 to form a color filter having a uniform thickness of the first and second color layers 130 and 140. Therefore, the hardened color filters may have a substantially flat shape at there tops, preventing the color filters from having a substantially dome shape as may occur if only discontinuous ejection into individual openings were employed.

Moreover, as shown in FIGS. 2 to 4B, the print head or the base substrate rotates at 180 degrees to eject the color inks into the second opening part after the print head ejects the color inks into the first opening part. Therefore, the second color layer 140 is formed, so that thickness uniformity of the color filters may be improved.

The color inks are ejected into the first openings 122, 122b and 122c by the print head, and the print head or the base substrate rotates to eject the color inks into the second opening parts 124a, 124b and 124c formed between the first opening parts 122a, 122b and 122c. Therefore, the color filters may be uniformly distributed on the color filter substrate 100.

Moreover, the color filters are ejected twice through the first ejecting process and the second ejecting process to have the first color layer and the second color layer, so that the thickness uniformity of the color filters is improved.

An amount of the color inks ejected by the print head may not be constant, so that color ink spots may be generated according to print directions of the print head. According to the present disclosure, however, the color ink spots are prevented. The color filters formed by substantially the same ejecting nozzle are disposed relatively randomly across the color filter substrate so that the color inks may have substantially the same effect as the color filters having uniform thickness. Therefore, quality of the color filters improves, and color reproducibility and display quality improves.

Furthermore, the color filters are formed through the first ejecting process and the second ejecting process, so that each of the color filters formed by the color inks does not have a dome shape, and the thickness uniformity of the color filters is improved. Therefore, performance and quality of the color filter improves, and color reproducibility and display quality improves.

Although the exemplary embodiments have been described, it is understood that the present disclosure should not be limited to these exemplary embodiments but various changes and modifications can be made by one ordinary skilled in the art within the spirit and scope of the present disclosure.

What is claimed is:

1. A method for providing pseudo random distribution of different ink ejections ejected by respective different nozzles into a matrix of openings defined in an in-process color filter substrate comprising:
(a) aligning a plurality of ejections nozzles according to a first angular orientation relative to a supplied in-process color filter substrate;
(b) first ejecting one or more inks into only a first subset of openings in the matrix; and
(c) aligning the plurality of ejections nozzles according to a second angular orientation relative to the supplied in-process color filter substrate where the second angular orientation is different from the first so that same nozzles will not persistently eject into immediately adjacent openings; and
(d) second ejecting one or more inks into a second subset of openings in the matrix, the second subset being different from the first subset.

2. A method of reducing or eliminating formation of top dome shapes when ejecting hardenable ink droplets by respective different nozzles into a matrix of separated openings defined in an in-process color filter substrate, the method comprising:
ejecting at least one layer of bridging ink which bridges across separation barriers between individual ones of the openings so as to thereby alter a top surface dome shape that would develop if ink were ejected only inside the separated openings and not bridging across the separation barriers.

3. A color filter substrate having a matrix of separated openings defined therein and comprising:
first and second interlaced sub-arrays of hardened ink ejections filling corresponding first and second interlaced sub-arrays of the separated openings, the first and second sub-arrays of hardened ink ejections being different from one another so that repetition idiosyncrasies of one of the first and second sub-arrays of hardened ink ejections are visually blended with different repetition idiosyncrasies of the other so as to create a more uniform visual effect than would be created if only one of said hardened ink ejections were used to fill the entire matrix of openings.

4. A color filter substrate having a matrix of separated openings defined therein and comprising:
a first layer of hardened ink ejections filling corresponding ones of the separated openings, and
a second layer of hardened ink ejections bridging across separation barriers between individual ones of the openings and covering dome shaped tops of hardened ink ejections of the first layer so as to thereby reduce nonplanarity of the dome-shaped tops of the first layer.

5. A method of manufacturing a color filter substrate, comprising:
first ejecting color inks only into a first sub-array of openings defined in or over a base substrate by using a print head unit that is in a first angular orientation relative to the color filter substrate, the print head unit including a plurality of ejecting nozzles;
changing the relative angular orientation between the base substrate and the print head unit; and
while in the changed angular orientation, second ejecting color inks only into a second sub-array of openings defined in or over a base substrate where the first and second sub-arrays are interlaced with one another.

6. The method of claim 5, wherein each of the first and second sub-arrays includes a first set of openings for receiving a first colored ink, a second set of openings for receiving a second colored ink and a third set of openings for receiving a third colored ink.

7. The method of claim 6, wherein the print head unit ejects the first, second and third colored one of the inks respectively into one of the first, second and third sets of openings.

8. The method of claim 6, wherein the print head unit comprises a first print head, a second print head and a third print head ejecting different color inks into the first opening, the second opening and the third sets of opening, respectively.

9. The method of claim 8, wherein ejecting the color inks into the first sub-array of openings comprises ejecting first, second and third color inks into the first, second and third sets of openings by the first print head filled with the first color ink, the second print head being filled with the second color ink and the third print head filled with the third color ink, respectively.

10. The method of claim 8, wherein the first, second and third print heads rotate with respect to one rotation axis.

11. The method of claim 10, where prior to ejecting the color inks into the second opening part, the method further comprises:
filling the third color ink into the first print head; and
filling the first color ink into the third print head.

12. The method of claim 11, wherein ejecting the color inks into the second opening part comprises:
ejecting the first color ink into the first opening of the second opening part;
ejecting the second color ink into the second opening; and
ejecting the third color ink into the third opening.

13. The method of claim 8, wherein each of the first, second and third print heads rotate with respect to an independent one of different rotation axes, respectively.

14. The method of claim 13, wherein the changing of the angular orientation of the first, second and third print heads comprises rotating the base substrate.

15. The method of claim 14, where prior to ejecting the color inks into the second opening part, the method further comprises:
filling the third color ink into the first print head; and
filling the first color ink into the third print head.

16. The method of claim 15, wherein ejecting the color inks into the second opening part comprises:
ejecting the first color ink into the first opening of the second opening part;
ejecting the second color ink into the second opening; and
ejecting the third color ink into the third opening.

17. The method of claim 14, where prior to ejecting the color inks into the second opening part, the method further comprises rearranging the first, second and third print heads on the first, second and third openings of the second opening part, the first, second and third print heads being filled with the first, second and third color inks, respectively.

18. A method of manufacturing a color filter substrate by using a print head unit ejecting color inks, comprising:
forming a light blocking layer defining a plurality of ink-receiving openings in or on a base substrate where the openings are separated from one another by separation barriers;
first ejecting discontinuously the color inks into the openings; and
second ejecting continuously the color inks into the openings so that the inks bridge across the separation barriers of immediately adjacent openings.

19. The method of claim 18, wherein the openings comprise a first opening part and a second opening part adjacent to the first opening part, and
each of the first and second opening parts comprises a first opening, a second opening and a third opening.

20. The method of claim 19, wherein the continuous ejecting comprises ejecting the color inks on the base substrate, and the base substrate includes different color inks respectively ejected into the first, second and third openings.

21. The method of claim 19, wherein at least one of the first ejecting and the second ejecting comprises:
ejecting the color inks into the first opening part by using a print head unit, the print head unit including a plurality of ejecting nozzles;
rotating relatively one of the base substrate and the print head unit; and
ejecting the color inks into the second opening part by using the print head unit.

22. The method of claim 21, wherein the print head unit comprises a first print head, a second print head and a third print head ejecting different color inks into the first opening, the second opening and the third opening, respectively.

23. The method of claim 24, where prior to ejecting the color inks into the second opening part, the method further comprises calibrating positions of the print head unit and the base substrate so that appropriate colors of inks will be ejected into predefined appropriate ones of the openings.

24. The method of claim 23, wherein the calibrating of the positions comprises changing color inks filled into print heads of the print head unit.

25. The method of claim 23, wherein the calibrating of the positions comprises changing the position of the print head unit, so that the first, second and third print heads respectively correspond to the first, second and third openings, respectively.
